(19) United States
(12) Patent Application Publication
(10) Pub. No.: US 2023/0371746 A1
(43) Pub. Date: Nov. 23, 2023

(54) BARBECUE GRILL OPERABLE TO CONTROL THE TASTE OF FOOD BY TEMPERATURE

(71) Applicant: REVOACE INC. LIMITED, Hong Kong (CN)

(72) Inventor: Kiosky Chung, Taichung (TW)

(21) Appl. No.: 17/745,879

(22) Filed: May 17, 2022

(51) Int. Cl. A47J 37/07; F24C 3/12; G01K 1/02

(52) U.S. Cl. CPC A47J 37/0786; A47J 37/0713; F24C 3/12; G01K 1/026

(57) ABSTRACT

A barbecue grill includes a cabinet, a burner module inserted in the cabinet, a gas supply module for connecting the burner module to a gas tank, a grid extending over the burner module, a lid for covering the grid, and a digital controller. The lid comprises a chamber. The digital controller includes a processor inserted in the cabinet, a convertor electrically connected to the processor, a chamber thermometer electrically connected to the convertor and inserted in the chamber, a food thermometer electrically connected to the converter, and an operation module electrically connected to the processor and operable to select a type of food and a degree of cooking so that the processor sets a temperature in the chamber and a temperature of food accordingly.

### BACKGROUND OF INVENTION

### 1. Field of Invention

The present invention relates to a barbecue grill and, more particularly, to a barbecue grill operable to control the taste of food by temperature.

### 2. Related Prior Art

A barbecue party is a popular outdoor activity enjoyable by a family or friends in gathering. An early-day barbecue grill includes a bowl, a lid pivotally connected to the bowl, and a grid. In use, the lid is pivoted from the bowl before charcoal is put in the bowl and ignited. The grid is placed on the bowl before food is laid on the grid and cooked. The taste of the food is determined by temperature and duration of cooking. It is essential to control the temperature to render the food delicious.

Steaks are often cooked in a barbecue party. A person may like a steak rare, medium, or well-cooked. The steak cannot be cooked properly if the temperature is too high or low. However, the early-day barbecue grill is simple functionally. A user of the early-day barbecue grill counts on his or her experience to control the temperature of cooking, and this is difficult.

A modern barbecue grill consumes gas as fuel. It is easier to control the temperature of cooking with the modern barbecue grill than with the early-day barbecue grill. Still, a user of the modern barbecue grill counts on his or her experience to control the temperature of cooking according to the type of food and how he or she likes the food cooked. In practice, the user observes how the food is cooked and accordingly controls the temperature of cooking. The user can observe only when he or she lifts the lid from the bowl because the lid is opaque. However, it is sometimes desirable to cook the food with the bowl closed by the lid. In such a case, the user must lift the lid from the bowl to observe the food from time to time. However, it is difficult to lift the lid from the cover at proper points of time. This makes it more difficult to cook the food to a desired extent.

Therefore, the present invention is intended to obviate or at least alleviate the problems encountered in the prior art.

### SUMMARY OF INVENTION

It is the primary objective of the present invention to provide a barbecue grill operable to control the temperature of cooking in a digital manner to ensure that food is cooked to a desired extent.

To achieve the foregoing objective, the barbecue grill includes a digital controller. The barbecue further includes a cabinet, a burner module inserted in the cabinet, a gas supply module for connecting the burner module to a gas tank, a grid extending over the burner module, a lid for covering the grid. The lid comprises a chamber. The digital controller includes a processor inserted in the cabinet, a convertor electrically connected to the processor, a chamber thermometer electrically connected to the convertor and inserted in the chamber, a food thermometer electrically connected to the converter, and an operation module electrically connected to the processor and operable to select a type of food and a degree of cooking so that the processor sets a temperature in the chamber and a temperature of food accordingly.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a barbecue grill according to the preferred embodiment of the present invention;

FIG. 2 is a block diagram of a digital controller used in the barbecue grill shown in FIG. 1;

FIG. 3 is a front view of a digital display and the digital controller shown in FIG. 2; and

FIG. 4 is a flow chart of a process for operating the barbecue grill shown in FIG. 1.

### DETAILED DESCRIPTION OF PREFERRED EMBODIMENT

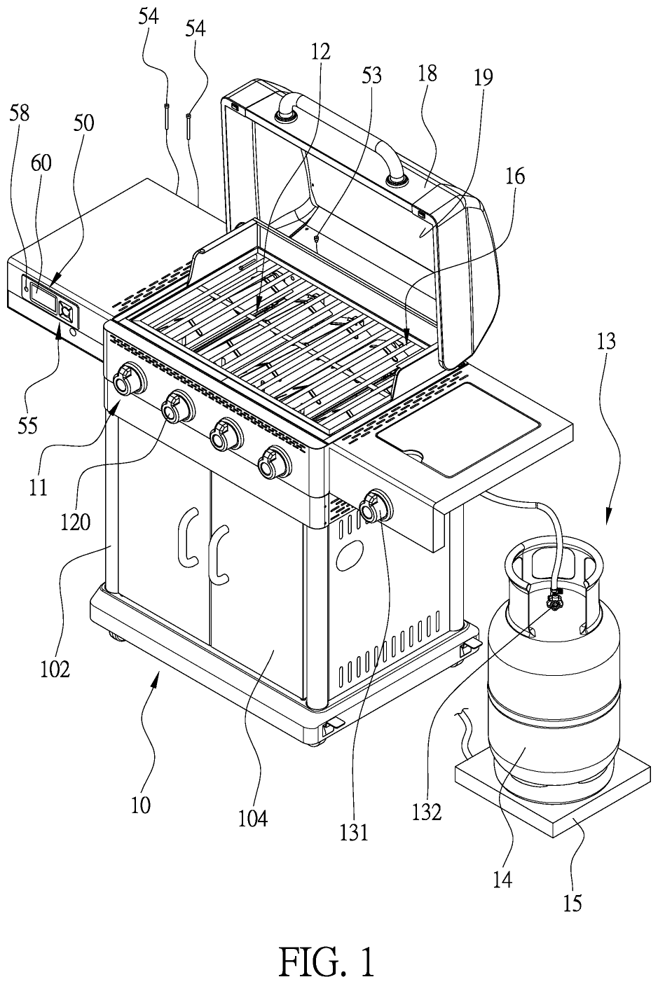

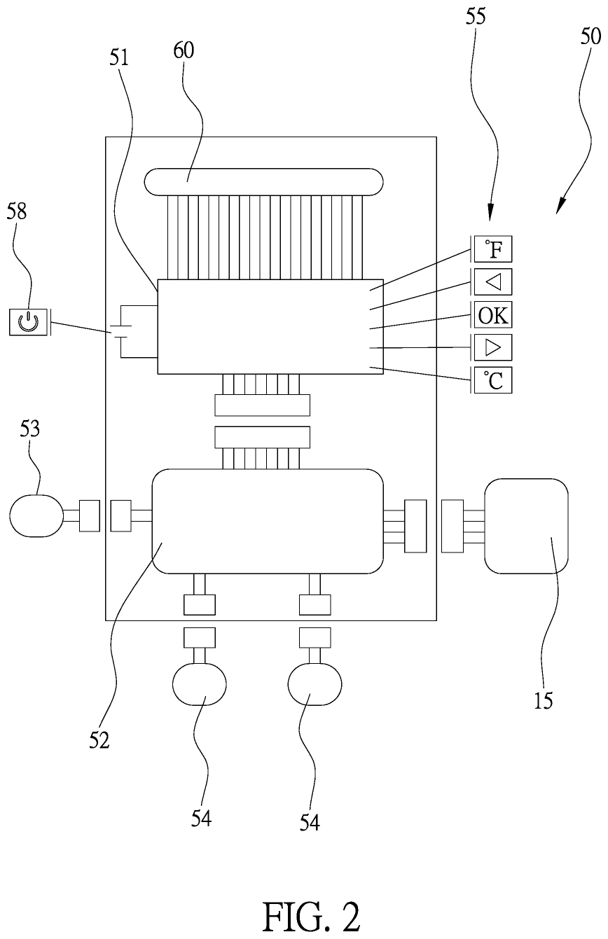

Referring to FIGS. 1 to 3, a barbecue grill includes a cabinet 10 and a digital controller 50 according to the preferred embodiment of the present invention. The barbecue grill is operable to control the taste of food by temperature.

The cabinet 10 includes a frame 102 and two doors 104. Each of the doors 104 is pivotally connected to the frame 102.

A burner module 11 includes several major gas burners 12 and a minor gas burner (not shown). The major gas burners 12 are inserted in an upper portion of the cabinet 10. Each of the major gas burners 12 is equipped with a knob 120 operable for controlling the corresponding major gas burner 12. The knobs 120 are supported on a front face of the upper portion of the cabinet 10. The minor gas burner includes a knob 131 operable for controlling the minor gas burner. The knob 131 is supported on a first table (not numbered) connected to a first lateral face of the upper portion of the cabinet 10.

A gas supply module 13 includes a piping (not numbered) and a joint/valve 132. At an end, the piping of the gas supply module 13 is connected to the burner module 11. At another end, the piping of the gas supply module 13 is connected to a gas tank 14 through the joint/valve 132. The joint/valve 132 is operated to communicate the burner module 11 with the gas tank 14 or shut the burner module 11 from the gas tank 14.

An electronic scale 15 is electrically connected to the digital controller 50. The electronic scale 15 is located next to the cabinet 10. In operation, the gas tank 14 is placed on the electronic scale 15 so that the electronic scale 15 is operated to weigh the gas tank 14 to determine how much gas is left in the gas tank 14.

A grid 16 is supported on the upper portion of the cabinet 10. The grid 16 is located above or over the burner module 11.

A lid 18 is used to cover the grid 16. Preferably, the lid 18 is pivotally connected to the upper portion of the cabinet 10. The lid 18 provides a chamber 19 in which food is contained when the grid 16 is covered with the lid 18.

The digital controller 50 includes a processor 51, a convertor 52, at least one chamber thermometer 53, at least one food thermometer 54, an operation module 55, and a switch 58. The entire digital controller 50 is powered by a power supply (not shown) that includes one power supply or more.

Preferably, the processor 51 and the convertor 52 are inserted in a second table (not numbered) attached to a second lateral face of the upper portion of the cabinet 10. The convertor 52 is electrically connected to the processor 51.

Preferably, only one chamber thermometer 53 is used. The chamber thermometer 53 is inserted in the chamber 19, thereby allowing the chamber thermometer 53 to detect the temperature in the chamber 19 during cooking. The chamber thermometer 53 is electrically connected to the convertor 52.

Preferably, two food thermometers 54 are used. Each of the food thermometers 54 is electrically connected to the convertor 52 via a wire. Preferably, each of the food thermometers 54 is in the form of a probe that is insertable in a piece or chunk of food to measure the temperature of the piece of food. That is, two pieces of food can be cooked with the barbecue grill at a time, and each of the food thermometers 54 is inserted in one of the pieces of food.

The scale 15 is also electrically connected to the convertor 52.

The convertor 52 converts the weight of the gas in the gas tank 14, the temperature in the chamber 19, and the temperature(s) of the piece(s) of food into proper signals before sending them to the processor 51.

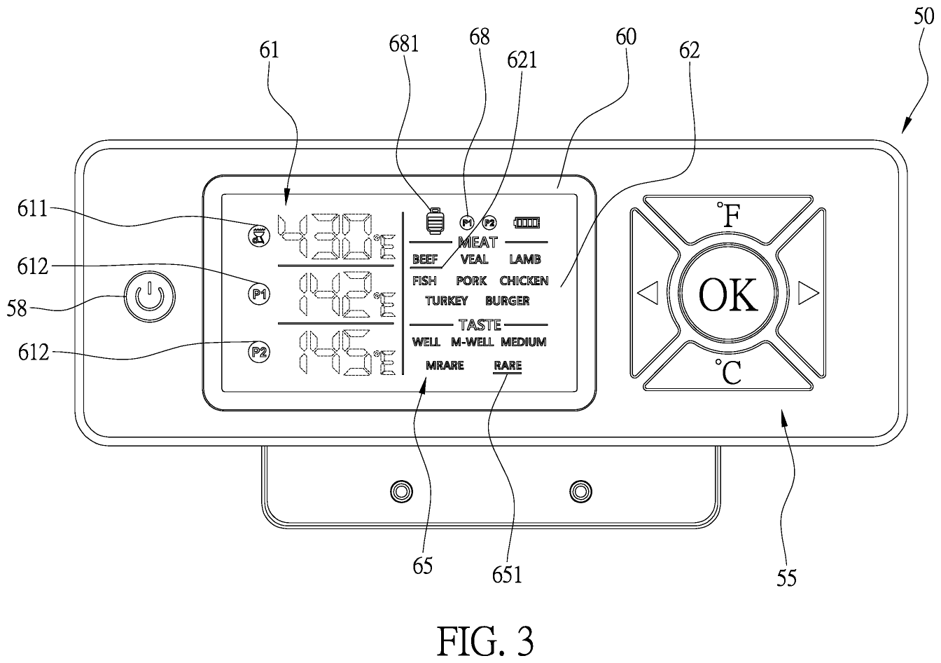

Preferably, the operation module 55 is in the form of a panel electrically connected to the processor 51. The operation module 55 is supported on the cabinet 10. The operation module 55 is operable to set a degree of cooking. Preferably, the operation module 55 includes a leftward button, a rightward button, a Celsius temperature-selecting button represented by “° C.” in FIG. 3, a Fahrenheit temperature-selecting button represented by “° F.” in FIG. 3, and one confirmation button.

The switch 58 is operable to turn on or off the digital controller 50. The switch 58 is supported on the cabinet 10.

A digital display 60 is electrically connected to the processor 51. The digital display 60 includes a temperature region 61, a food-type region 62, and a degree-of-cooking region 65.

Preferably, the temperature region 61 includes a chamber temperature region 611 and two food temperature regions 612. The chamber temperature region 611 shows the temperature measured with the chamber thermometer 53. Each of the food temperature regions 612 shows a temperature measured with one of the food thermometers 54. Preferably, the temperature regions 612 are represented by icons “P1” and “P2”, respectively.

Preferably, the food-type region 62 includes food-type icons 621 corresponding to beef, veal, lamb, fish, pork, chicken, turkey, and hamburger.

Preferably, the degree-of-cooking region 65 includes degree-of-cooking icons 651 corresponding to RARE, M-RARE, MEDIUM, M-WELL and WELL-DONE. The processor 51 stores various temperatures corresponding to the degree-of-cooking icons 651. A relationship between the type of the food, the degrees of cooking, and the temperatures is described in Table 1.

TABLE 1

| FOOD | RARE | M-RARE | MEDIUM | M-WELL | WELL-DONE |
|---|---|---|---|---|---|
| BEEF | 145° F. | 151° F. | 160° F. | 165° F. | 171° F. |
| VEAL | | 151° F. | 160° F. | 165° F. | 171° F. |
| LAMB | 145° F. | 151° F. | 160° F. | 165° F. | 171° F. |
| FISH | | | | | 145° F. |
| PORK | | | 160° F. | 165° F. | 171° F. |
| CHICKEN | | | | | 165° F. |
| TURKEY | | | | | 165° F. |
| BURGER | | | | | 165° F. |

In an embodiment, the digital display 60 further includes an alert-displaying region 68. Preferably, the alert-displaying region 68 includes various alert icons 681 corresponding to the weight of gas, the quantity of electricity of the power supply, and the food temperature. Hence, one of the alert icons 681 lights up the digital display 60 when the weight of gas, the quantity of electricity of the power supply or the food temperature reaches a limit.

Although not shown, a speaker can be electrically connected to the processor 51. Thus, such a speaker sends a loud sound as one of the alert icons 681 lights up when the weight of gas, the quantity of electricity of the power supply or the food temperature reaches a limit.

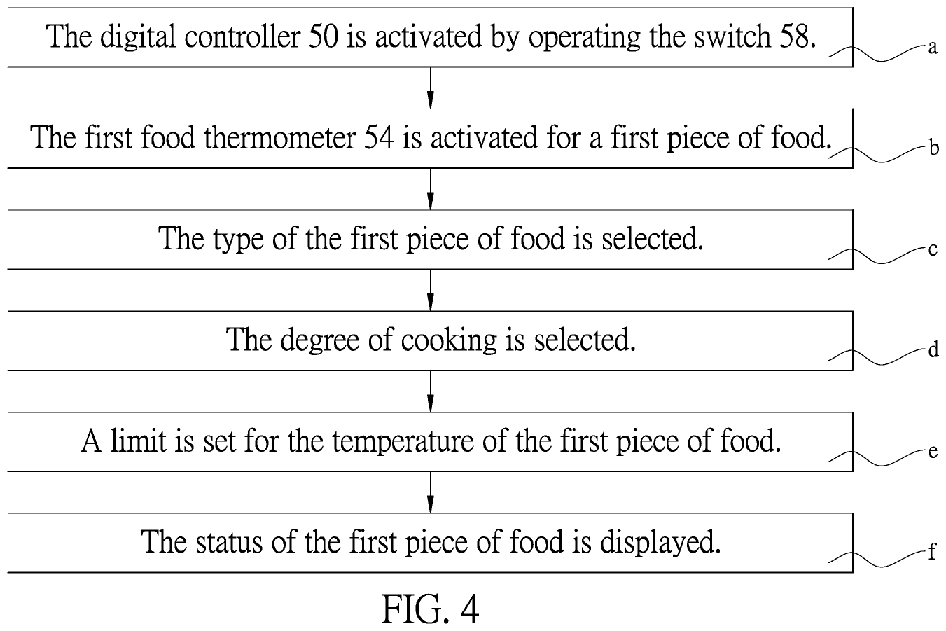

Referring to FIGS. 1, 3 and 4, the use of the barbecue grill will be described in detail. The knobs 120 are operated to allow the gas to go to the major gas burners 12 via the gas supply module 13. The barbecue grill can be operated in two modes.

In the first mode, the barbecue grill operates like a typical barbecue grill. At a, the digital controller 50 is activated by operating the switch 58. The processor 51 receives a signal about the temperature in the chamber 19 from the chamber thermometer 53 via the convertor 52 and instructs the chamber temperature region 611 of the digital display 61 to show the temperature in the chamber 19. The operation module 55 is operated to select the Celsius or Fahrenheit scale. In detail, the leftward and rightward buttons are operable to switch between the icons ° C. and ° F. For example, the user chooses the Celsius scale by pressing the confirmation button OK for two seconds when the icon ° C. is lighted.

Unlike the typical barbecue grill, the processor 51 receives a signal about the weight of the gas in the gas tank 14 from the electronic scale 15 through the convertor 52. The digital controller 50 instructs the digital display 60 to show an alert when the weight of the gas in the tank 14 reaches a limit.

The processor 51 receives a signal about the electricity in the power supply of the digital controller 50. The digital controller 50 instructs the digital display 60 to show an alert when the quantity of the electricity reaches a limit.

In the second mode, the barbecue grill operates like a smart barbecue grill. At a, the digital controller 50 is activated by operating the switch 58. The processor 51 receives a signal about the temperature in the chamber 19 from the chamber thermometer 53 via the convertor 52 and instructs the chamber temperature region 611 of the digital display 60 to show the temperature in the chamber 19. The operation module 55 is operated to select the Celsius or Fahrenheit scale.

At b, the first food thermometer 54 is activated for a first piece of food. The user inserts the first food thermometer 54 in the first piece of food. The user is allowed to operate the leftward and rightward buttons to switch between the food temperature regions 612, i.e., the icons P1 and P2. The user chooses the first food thermometer 54 by pressing the confirmation button OK for two seconds when the icon P1 is lighted. Accordingly, the processor 51 receives a signal about the temperature of the first piece of food from the first food thermometer 54 through the convertor 52 and instructs the first food temperature region 612 to show the temperature of the first piece of food. The operation module 55 is operated to select the Celsius or Fahrenheit scale.

At c, the type of the first piece of food is selected. The operation module 55 is operated to select beef, veal, lamb, fish, pork, chicken, turkey, or hamburger. The food-type region 62 of the digital display 60 shows the type of the first piece of food.

At d, the degree of cooking is selected. The operation module 55 is operated to select WELL-DONE, M-WELL, MEDIUM, M-RARE, or RARE. The degree-of-cooking region 65 of the digital display 60 shows the degree of cooking.

At e, a limit is set for the temperature of the first piece of food. The digital controller 50 sets a limit for the temperature of the first piece of food according to type of the first piece of food and the degree of cooking the first piece of food.

At f, the status of the first piece of food is displayed. To this end, the first food thermometer 54 measures the temperatures of the pieces of food, and the first food-temperature region 612 of the digital display 60 shows the temperatures of the pieces of food.

In addition, the processor 51 receives a signal about the weight of the gas in the gas tank 14 from the electronic scale 15 via the convertor 52. The digital controller 50 instructs the digital display 60 to show an alert when the weight of the gas in the tank 14 reaches a limit.

The processor 51 receives a signal about the electricity in the power supply of the digital controller 50. The digital controller 50 instructs the digital display 60 to show an alert when the quantity of the electricity reaches a limit.

To synchronously cook a second piece of food, the user inserts the second food thermometer 54 in the second piece of food and activates the second food thermometer 54 by pressing the confirmation button OK for two seconds when the icon P2 is lighted. The steps represented by b to f are repeated for the second piece of food.

As described above, the barbecue grill is operable to precisely control the temperature of cooking and the degree of cooking. Hence, a user of the barbecue grill is allowed to provide delicious food without having to rely on his or her experience.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A barbecue grill comprising:
a cabinet;
a burner module inserted in the cabinet;
a gas supply module for connecting the burner module to a gas tank;
a grid extending over the burner module;
a lid for covering the grid, wherein the lid comprises a chamber; and
a digital controller comprising:
a processor inserted in the cabinet;
a convertor electrically connected to the processor;
a chamber thermometer electrically connected to the convertor, wherein the chamber thermometer is inserted in the chamber;
a food thermometer electrically connected to the converter; and
an operation module electrically connected to the processor and operable to select a type of food and a degree of cooking so that the processor sets a temperature in the chamber and a temperature of food accordingly.

2. The barbecue grill according to claim 1, wherein the cabinet comprises a frame and two doors connected to the frame.

3. The barbecue grill according to claim 1, wherein the burner module comprises at least one gas burner and at least one knob operable to control a rate of gas to the gas burner.

4. The barbecue grill according to claim 2, wherein the gas supply module comprises a piping comprising an end connected to the gas burner and a joint/valve for connecting another end of the piping to the gas tank.

5. The barbecue grill according to claim 1, further comprising an electronic scale electrically connected to the processor via the convertor, wherein the electronic scale is operable to weigh the gas tank.

6. The barbecue grill according to claim 1, wherein the digital controller comprises two food thermometers.

7. The barbecue grill according to claim 1, wherein the operation module further comprises a leftward button, a rightward button, a Celsius button, a Fahrenheit button, and a confirmation button.

8. The barbecue grill according to claim 1, wherein the operation module further comprises a movement button, at least one temperature-selecting button, and a confirmation button.

9. The barbecue grill according to claim 1, wherein the digital controller comprises a switch operable to turn on and off the digital controller.

10. The barbecue grill according to claim 1, further comprising a digital display electrically connected to the processor.

11. The barbecue grill according to claim 10, wherein the digital display comprises:
a chamber temperature region;
a food temperature region;
a food-type region comprising several food-type icons; and
a degree-of-cooking region comprising several degree-of-cooking icons.

12. The barbecue grill according to claim 10, wherein the digital display further comprises an alert-displaying region comprising at least one an alert icon.

13. The barbecue grill according to claim 1, wherein the digital controller comprises two food thermometers.
